(19) United States
(12) Patent Application Publication
(10) Pub. No.: US 2022/0318122 A1
(43) Pub. Date: Oct. 6, 2022

(54) METHOD AND SYSTEM FOR BLOCKCHAIN PERFORMANCE TESTING

(71) Applicant: MASTERCARD INTERNATIONAL INCORPORATED, Purchase, NY (US)

(72) Inventors: Keith HUGHES, Wicklow (IE); Thomas TREITLINGER, Portmarnock (IE)

(73) Assignee: MASTERCARD INTERNATIONAL INCORPORATED, Purchase, NY (US)

(21) Appl. No.: 17/222,207

(22) Filed: Apr. 5, 2021

(51) Int. Cl. G06F 11/34; H04L 9/06

(52) U.S. Cl. CPC G06F 11/3428; H04L 9/0618; H04L 9/0643; H04L 9/0656; H04L 2209/38

(57) ABSTRACT

A method for autonomous determination of performance metrics in a blockchain network through randomly generated transactions includes: receiving, by a blockchain node in a blockchain network, a testing instruction including testing criteria; generating, by the blockchain node, a number of new blockchain transactions using random generation based on the testing criteria; submitting, by the blockchain node, the new blockchain transactions into a pending transaction queue in the blockchain network; monitoring, by the blockchain node, performance values for nodes in the blockchain network and performance values for the blockchain network; identifying, by the blockchain node, performance metrics based on the testing criteria and at least one of: the performance values for the nodes and the performance values for the blockchain network; and transmitting, by blockchain node, the identified performance metrics in response to the received testing instruction.

### FIELD

The present disclosure relates to autonomous determination of performance metrics in a blockchain network through randomly generated transactions, specifically the introduction of fake transactions in a blockchain network and the monitoring of performance of the blockchain network and nodes included therein in accordance with testing criteria to measure performance metrics in the blockchain network.

### BACKGROUND

Blockchain was initially created as a storage mechanism for use in conducting payment transactions with a cryptographic currency. Using a blockchain provides a number of benefits, such as decentralization, distributed computing, transparency regarding transactions, and yet also providing anonymity as to the individuals or entities involved in a transaction. One of the more popular aspects of a blockchain is that it is an immutable record: every transaction ever that is part of the chain is stored therein and cannot be changed due to the computational requirements and bandwidth limitations, particularly as a chain gets longer and a blockchain network adds more nodes.

The immutability of blockchains, as well as the lack of centralization, makes it difficult, if not impossible, to accurately measure performance metrics for the blockchain network or to perform load testing or other performance testing. Because there is no central area of a blockchain network for traffic, there are no single throughputs in the network for capturing metrics. Additionally, the immutability of a blockchain can make testing difficult. Currently there are no tests or environments that can capture performance metrics of a blockchain or a blockchain node in its operation as a node in a blockchain network. Instead, performance testing is limited to performance of nodes as computing devices generally, which does not provide many useful measurements for performance of a blockchain network in carrying out its natural functions, which is prohibitive for designing or implementing improvements in a blockchain network. Thus, there is a need for a technical system that is able to measure performance of a blockchain network and nodes included therein in a manner that does not disrupt the operation of the blockchain itself.

### SUMMARY

The present disclosure provides a description of systems and methods for autonomous determination of performance metrics in a blockchain network through randomly generated transactions. A node in a blockchain network, which may be a specialized testing node or any blockchain node that may be specially configured to perform such functions, may receive testing instructions and may design testing parameters to match the instructions. The node may generate fake transactions that will pass confirmation by other nodes in the blockchain network and start adding the fake transactions into a pending transaction queue in a manner that satisfies the test instructions. The node monitors performance of the blockchain network and nodes included therein while the fake transactions are pending and processed, and the node can identify performance metrics once the fake transactions are all added into the blockchain. The use of fake transactions that can pass confirmation means that the testing can occur in a live environment without disrupting the blockchain. At the same time, having the performance being tested by a blockchain node itself ensures that all possible performance values are captured, and accurately, and can measure traffic and values unavailable to a computing device that is monitoring published traffic without being a node in the blockchain network. Thus, the methods and systems discussed herein can autonomously capture valuable performance metrics for a blockchain network and its nodes, even in a live environment situation on the blockchain without threatening the blockchain itself or compromising any data included therein.

A method for autonomous determination of performance metrics in a blockchain network through randomly generated transactions includes: receiving, by a receiver in a blockchain node in a blockchain network that manages a blockchain, a testing instruction, where the testing instruction includes at least one testing criteria; generating, by a processor of the blockchain node, a plurality of new blockchain transactions using random generation, where a number of the plurality of blockchain transactions is based on the at least one testing criteria; submitting, by a transmitter of the blockchain node, the generated plurality of new blockchain transactions into a pending transaction queue in the blockchain network; monitoring, by the processor of the blockchain node, a plurality of performance values for one or more nodes in the blockchain network and a plurality of performance values for the blockchain network, where the one or more nodes includes the blockchain node and/or additional nodes in the blockchain network; identifying, by the processor of the blockchain node, one or more performance metrics based on the at least one testing criteria and at least one of: the plurality of performance values for the one or more nodes and the plurality of performance values for the blockchain network; and transmitting, by the transmitter of the blockchain node, the identified one or more performance metrics in response to the received testing instruction.

A system for autonomous determination of performance metrics in a blockchain network through randomly generated transactions includes: a blockchain network that manages a blockchain; and one or more nodes included in the blockchain network, where the one or more nodes includes a blockchain node and additional nodes, and the blockchain node includes a receiver receiving a testing instruction, where the testing instruction includes at least one testing criteria, a processor generating a plurality of new blockchain transactions using random generation, where a number of the plurality of blockchain transactions is based on the at least one testing criteria, and a transmitter submitting the generated plurality of new blockchain transactions into a pending transaction queue in the blockchain network, wherein the processor of the blockchain node monitors a plurality of performance values for one or more nodes in the blockchain network and a plurality of performance values for the blockchain network, where the one or more nodes includes the blockchain node and/or additional nodes in the blockchain network, and identifies one or more performance metrics based on the at least one testing criteria and at least one of: the plurality of performance values for the one or more nodes and the plurality of performance values for the blockchain network, and the transmitter of the blockchain node transmits the identified one or more performance metrics in response to the received testing instruction.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for performance testing in a blockchain network in accordance with exemplary embodiments.

FIG. 2 is a block diagram illustrating a blockchain node of the system of FIG. 1 for performance testing in a blockchain network in accordance with exemplary embodiments.

FIG. 3 is a flow diagram illustrating a process for monitoring performance of a blockchain network and blockchain nodes using fake transactions in accordance with exemplary embodiments.

FIG. 4 is a flow chart illustrating an exemplary method for autonomous determination of performance metrics in a blockchain network through randomly generated transactions in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

### System for Blockchain Performance Testing

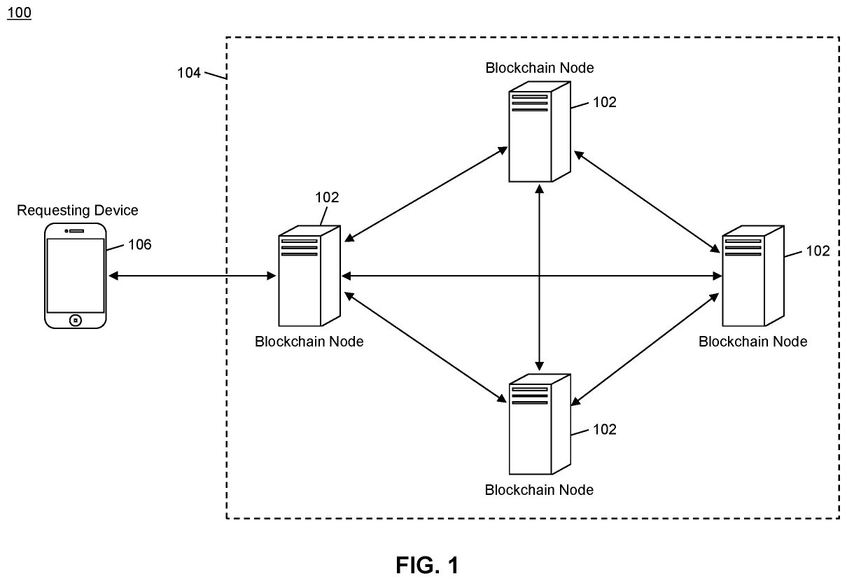

FIG. 1 illustrates a system 100 for identifying performance metrics in a blockchain based on performance of a blockchain network and blockchain nodes included therein through the use of fake transactions and monitoring by a blockchain node in the blockchain network.

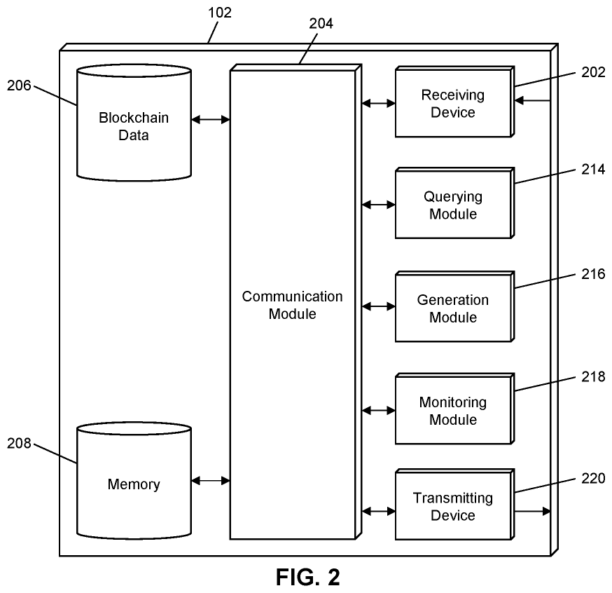

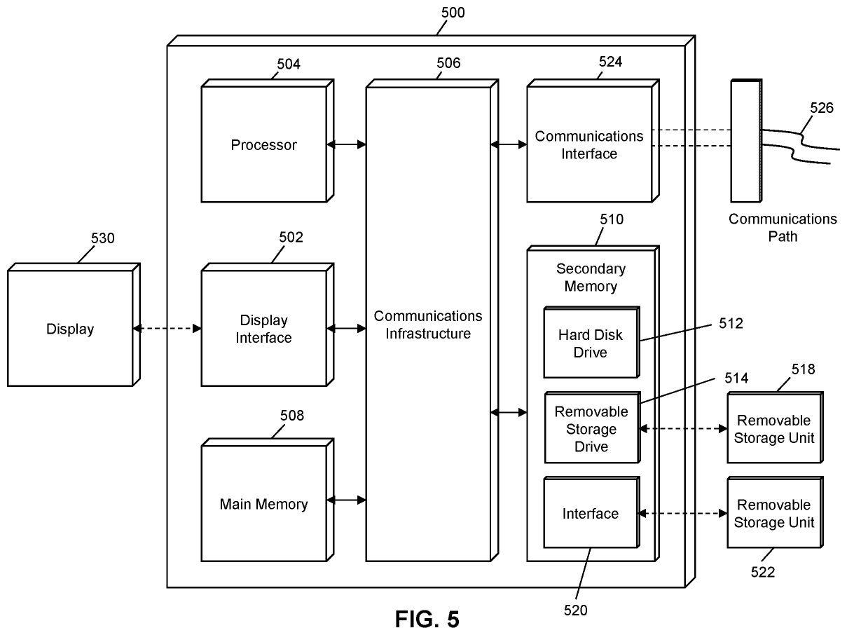

The system 100 may include a blockchain network 104. The blockchain network 104 may be comprised of a plurality of blockchain nodes 102. Each blockchain node 102 may be a computing system, such as illustrated in FIGS. 2 and 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain may be a distributed ledger that is comprised of at least a plurality of blocks. Each block may include at least a block header and one or more data values. Each block header may include at least a timestamp, a block reference value, and a data reference value. The timestamp may be a time at which the block header was generated and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single node in the blockchain network 104 prior to the generation and addition of a new block to the blockchain in order for the change to be made permanent. Computational and communication limitations may make such a modification exceedingly difficult, if not impossible, thus rendering the blockchain immutable.

In some embodiments, the blockchain may be used to store information regarding blockchain transactions conducted between two different blockchain wallets. A blockchain wallet may include a private key of a cryptographic key pair that is used to generate digital signatures that serve as authorization by a payer for a blockchain transaction, where the digital signature can be verified by the blockchain network 104 using the public key of the cryptographic key pair. In some cases, the term “blockchain wallet” may refer specifically to the private key. In other cases, the term “blockchain wallet” may refer to a computing device that stores the private key for use thereof in blockchain transactions. For instance, each computing device may each have their own private key for respective cryptographic key pairs and may each be a blockchain wallet for use in transactions with the blockchain associated with the blockchain network. Computing devices may be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain may correspond to a blockchain transaction or other storage of data, as applicable. A blockchain transaction may consist of at least: a digital signature of the sender of currency that is generated using the sender's private key, a blockchain address of the recipient of currency generated using the recipient's public key, and a blockchain currency amount that is transferred or other data being stored. In some blockchain transactions, the transaction may also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction may also include the sender's public key, for use by an entity in validating the transaction. For the traditional processing of a blockchain transaction, such data may be provided to a blockchain node 102 in the blockchain network 104, either by the sender or the recipient. The node may verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block may be validated by other nodes in the blockchain network 104 before being added to the blockchain and distributed to all of the blockchain nodes 102 in the blockchain network 104 in traditional blockchain implementations. In cases where a blockchain data value may not be related to a blockchain transaction, but instead the storage of other types of data, blockchain data values may still include or otherwise involve the validation of a digital signature.

In the system 100, a blockchain node 102 may be configured to facilitate performance testing for the blockchain network 104. In some embodiments, only some blockchain nodes 102 may be configured for performance testing, while other blockchain nodes 102 may be configured to perform only traditional functions as a node in the blockchain network 104. In some such embodiments, a testing blockchain node 102 may be configured to monitor performance values for itself as a blockchain node 102 and other testing blockchain nodes 102 and may, in some cases, be unable to monitor performance values in non-testing blockchain nodes 102. For example, blockchain nodes 102 in traditional blockchain networks 104 may not capture data suitable for measuring of performance values and thus a blockchain node 102 may have to be specially configured for measuring performance values as discussed herein for monitoring of performance in the system 100.

When a test is to be performed, a blockchain node 102 that is configured for performance testing may receive a testing instruction. The testing instruction may be entered into the blockchain node 102 via an input device interfaced therewith, such as by a user using a terminal of the blockchain node 102, or may be received via an electronic transmission from another computing device, such as a requesting device 106. The requesting device 106 may be any type of computing device suitable for capturing user input and transmitting data to the blockchain node 102 using any suitable communication network and method. The requesting device 106 may be, for example, a desktop computer, laptop computer, notebook computer, tablet computer, cellular phone, smart phone, smart watch, smart television, wearable computing device, implantable computing device, etc., and the communication network and method may include or utilize the Internet, a local area network, a wide area network, radio frequency, Bluetooth, near field communication, etc.

The testing instruction may include one or more testing criteria, which the blockchain node 102 may use in developing test parameters for measuring performance in the blockchain network 104. The test criteria may, for instance, be a request that specifies performance metrics to be identified, sets parameters for the test, places limitations on test parameters, etc. In one example, the testing criteria may be to test performance of the blockchain network 104 and blockchain nodes 102 at a specified number of transactions per second. In another example, the testing criteria may be to identify the maximum number of transactions per second that can be processed in the blockchain network 104 while maintaining a specific, maximum confirmation time and maximum processor usage in blockchain nodes 102. In yet another example, the testing criteria may request performance metrics for the blockchain network 104 after receiving a single submission of an excessive number of new transactions.

The blockchain node 102 may be configured to generate test parameters in order to identify performance metrics in satisfaction of the test criteria. In the first example, the test parameters may include forcing a number of transactions per second, setting a maximum amount of time for the test, and capturing performance values that may be suitable for the requesting device 106. In the second example, the test parameters may include a base limit of transactions per second, a maximum limit of transactions per second, a rate of increase of transactions per second, and a limitation on confirmation time. In the third example, the test parameters may include a number of transactions to be generated and performance values to be captured following the submission thereof. Test parameters and test criteria may include any suitable values, such as transactions per second, base transactions per second, maximum transactions per second, increase rate of transactions per second, time limit, transaction limit, and hash size. In some instances, one or more test parameters or criteria may be set for the entire blockchain network 104, which may thereby be distributed to blockchain nodes 102, such as through any traditional configuration methods for a blockchain network 104.

Once the test parameters have been identified, the blockchain node 102 may generate a plurality of fake transactions in accordance with the test parameters. In some cases, the blockchain node 102 may generate all fake transactions to be used in the test prior to commencing the test. In other cases, the blockchain node 102 may continue to generate fake transactions while the test is being performed, such as to maintain a number of transactions per second (e.g., if the full transactions for the entire test period are not all generated prior to start of the test), or for increased efficiency in operation of the blockchain node 102 and blockchain network 104 (e.g., to commence the test earlier instead of spending more time generating fake transactions prior to commencement).

Fake transactions may be blockchain data values that may pass confirmation by other blockchain nodes 102 in the blockchain network 104, but where addition of the blockchain data values in the blockchain may result in no exchange of value for any blockchain wallets that utilize the blockchain network 104 apart from the blockchain node 102 managing the performance testing of the blockchain network 104. As discussed herein, the term “fake” is used to refer to these transactions to differentiate these types of transactions from traditional blockchain transactions for the exchange of digital assets or other data usages, although the fake transactions still appear to and will be processed by blockchain nodes 102 in the same manner as traditional blockchain transactions. The contents of a fake transaction may be based on the blockchain data values in the blockchain, which may vary depending on use of the blockchain and its implementation. For instance, if the blockchain is used to store hash values that are references to transactions or other data, each fake transaction may be a randomly generated value that is the same data size as the hash values and fulfills any criteria thereof, such as being a 64-digit alphanumeric value. In another example, if the blockchain is used for cryptographic currency transactions, the fake transactions may include a transfer of a nominal amount of cryptographic currency back and forth between blockchain wallets possessed or otherwise managed by the testing blockchain node 102. In some instances, a fake transaction may include a flag or other value that indicates that the transaction should be confirmed without specific validation of data included therein, which may be processed accordingly by blockchain nodes 102 if specially configured for such processing.

Once the fake transactions are generated, the blockchain node 102 may submit fake transactions into a pending transaction queue in the blockchain network 104 in accordance with the test parameters. For instance, in the first example above, fake transactions may be submitted to maintain a specific number of transactions per second being received in the blockchain network. In the second example above, the number of fake transactions may be submitted in an increasing manner that increases the number of transactions per second received in the blockchain network 104 at the specified rate in the test parameters. In instances where the blockchain network 104 is operating a live environment where the blockchain may continue operation during performance testing, the blockchain node 102 may determine transactions per second that is also based on real transactions being submitted into the blockchain network 104 for processing, where the number and rate of fake transactions being submitted is modified accordingly.

The blockchain node 102 may be configured to monitor performance values of blockchain nodes 102 in the blockchain network 104 and/or the blockchain network 104 itself for performance testing. In some cases, monitoring may commence with the introduction of the first fake transactions in the pending transaction queue. In other cases, monitoring may commence prior to introduction of the first take transactions, such as to capture baseline performance values that may be used in measuring performance following the introduction of the fake transactions. To monitor performance values, the blockchain node 102 may monitor any data that may be captured from the blockchain network 104 and blockchain nodes 102 as the nodes confirm transactions in the pending transaction queue and generate new blocks that include confirmed transactions, which are then confirmed and added to the blockchain in the blockchain network 104. In some embodiments, only blockchain nodes 102 that are configured for monitoring may be monitored by the testing blockchain node 102. For example, such blockchain nodes 102 may be configured to report such data when requested, or may otherwise make such data available, such as via an application programming interface.

The blockchain node 102 may continue to monitor performance values through the test, where the length of the test may be based on or set in the test parameters. For instance, in the first example above, the test may go on for a set period of time, while, in the second example above, the test may continue until a maximum number of transactions per second has been identified. The blockchain node 102 may monitor any performance values that are capable of being measured in the blockchain network 104 and/or blockchain nodes 102 as may be desired. Performance values may include, for instance, processor usage, memory usage, confirmation time for transactions, confirmation time for blocks, level of synchronization, size of pending transaction queue, number of transmitted messages, number of confirmation messages, average block size, etc., which may be measured for the blockchain network 104, individual blockchain nodes 102, groups of blockchain nodes, etc., and may be represented as independent values for each blockchain node 102 or may be an average of blockchain nodes 102 or groups of blockchain nodes 102.

Once the testing has been completed, the blockchain node 102 may identify performance metrics in accordance with the testing criteria using the performance values monitored for the blockchain nodes 102 and/or blockchain network 104. The performance metrics may then be transmitted to the requesting device 106 or otherwise transmitted in response to the testing request. For instance, if the testing instructions are submitted in an input device of the blockchain node 102 itself, the test results (e.g., identified performance metrics) may be displayed on a display device interfaced with the blockchain node 102. In some cases, the requesting device 106 may request additional testing, such as through other testing criteria, modifications to the test parameters, etc. In some instances, the requesting device 106 may request other performance metrics, where the blockchain node 102 may identify the performance metrics using the performance values captured through monitoring during the test, which may be identified without running another test.

In embodiments where the blockchain network 104 may include blockchain nodes 102 situated through a large geographic area, performance testing may take into account the geographic location of blockchain nodes 102. For instance, if the blockchain network 104 is spread across the world, the testing blockchain node 102 may measure performance for blockchain nodes 102 in specific geographic areas, such as by identifying different performance metrics based on region. In another example, the submission of fake transactions into a pending transaction queue may include transmission of the fake transactions to blockchain nodes 102 located in specific geographic areas. For instance, one test may include introducing 1,000 fake blockchain transactions into ten different geographic areas, one geographic area at a time, to determine differences in performance for the blockchain network 104. In such cases, the testing criteria may specify requests or limitations with respect to geographic areas.

In some embodiments, testing blockchain nodes 102 may be configured to perform testing in a manner that minimizes an effect on the processing of real transactions in a blockchain network 104 that operates as live environment. For instance, the testing blockchain node 102 may perform testing during slower times of real transactions based on measured load of the blockchain network 104, which may be monitored by the testing blockchain node 102 outside of performance tests.

The methods and systems discussed herein enable performance testing to be conducted in a blockchain network 104. The performance testing may include the introduction of fake transactions into the blockchain network 104, where a testing blockchain node 102 may monitor performance values of the blockchain network 104, itself, and other blockchain nodes 102. By using fake transactions, testing criteria can be met and performance measured that may be otherwise unavailable in basic operation of the blockchain network 104. In addition, introducing fake transactions may enable testing to be performed in a live environment without affecting the operation of the blockchain network 104 for real transactions. The result is that useful metrics for the blockchain network 104 and blockchain nodes 102 can be captured without disruption of a live blockchain, and where legacy blockchain nodes 102 can still be used for operation of the blockchain.

### Blockchain Node

FIG. 2 illustrates an embodiment of the blockchain node 102 in the system 100. It will be apparent to persons having skill in the relevant art that the embodiment of the blockchain node 102 illustrated in FIG. 2 is provided as illustration only and may not be exhaustive to all possible configurations of the blockchain node 102 suitable for performing the functions as discussed herein. For example, the computer system 500 illustrated in FIG. 5 and discussed in more detail below may be a suitable configuration of the blockchain node 102.

The blockchain node 102 may include a receiving device 202. The receiving device 202 may be configured to receive data over one or more networks via one or more network protocols. In some instances, the receiving device 202 may be configured to receive data from other blockchain nodes 102, requesting devices 106, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by other blockchain nodes 102 that may be superimposed or otherwise encoded with new transactions for confirmation, confirmed blockchain transactions, new blocks for confirmation, confirmed blocks for addition to the blockchain, messages regarding block confirmations, performance values, etc. The receiving device 202 may also be configured to receive data signals electronically transmitted by requesting devices 106, which may be superimposed or otherwise encoded with testing criteria, testing parameters, performance metric requests, etc.

The blockchain node 102 may also include a communication module 204. The communication module 204 may be configured to transmit data between modules, engines, databases, memories, and other components of the blockchain node 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the blockchain node 102 and external components of the blockchain node 102, such as externally connected databases, display devices, input devices, etc. The blockchain node 102 may also include a processing device. The processing device may be configured to perform the functions of the blockchain node 102 discussed herein as will be apparent to persons having skill in the relevant art. In some embodiments, the processing device may include and/or be comprised of a plurality of engines and/or modules specially configured to perform one or more functions of the processing device, such as a querying module 214, generation module 216, monitoring module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The blockchain node 102 may also include a memory 208. The memory 208 may be configured to store data for use by the blockchain node 102 in performing the functions discussed herein, such as public and private keys, symmetric keys, etc. The memory 208 may be configured to store data using suitable data formatting methods and schema and may be any suitable type of memory, such as read-only memory, random access memory, etc. The memory 208 may include, for example, encryption keys and algorithms, communication protocols and standards, data formatting standards and protocols, program code for modules and application programs of the processing device, and other data that may be suitable for use by the blockchain node 102 in the performance of the functions disclosed herein as will be apparent to persons having skill in the relevant art. In some embodiments, the memory 208 may be comprised of or may otherwise include a relational database that utilizes structured query language for the storage, identification, modifying, updating, accessing, etc. of structured data sets stored therein. The memory 208 may be configured to store, for example, cryptographic keys, salts, nonces, communication information for blockchain nodes 102 and blockchain networks 104, address generation and validation algorithms, digital signature generation and validation algorithms, hashing algorithms for generating reference values, rules regarding generation of new blocks and block headers, a pending transaction queue, geographic location data, performance values, testing criteria, test parameters, etc.

The blockchain node 102 may also include blockchain data 206, which may be stored in the memory 208 of the blockchain node 102 or stored in a separate area within the blockchain node 102 or accessible thereby. The blockchain data 206 may include a blockchain, which may be comprised of a plurality of blocks and be associated with the blockchain network 104. In some cases, the blockchain data 206 may further include any other data associated with the blockchain and management and performance thereof, such as block generation algorithms, digital signature generation and confirmation algorithms, communication data for blockchain nodes 102, a pending transaction queue, etc.

The blockchain node 102 may include a querying module 214. The querying module 214 may be configured to execute queries on databases to identify information. The querying module 214 may receive one or more data values or query strings and may execute a query string based thereon on an indicated database, such as the memory 208 of the blockchain node 102 to identify information stored therein. The querying module 214 may then output the identified information to an appropriate engine or module of the blockchain node 102 as necessary. The querying module 214 may, for example, execute a query on the memory 208 to identify blockchain wallet data for use in the generation of fake transactions, or to identify test parameters for use in monitoring performance metrics for performance testing.

The blockchain node 102 may also include a generation module 216. The generation module 216 may be configured to generate data for use by the blockchain node 102 in performing the functions discussed herein. The generation module 216 may receive instructions as input, may generate data based on the instructions, and may output the generated data to one or more modules of the blockchain node 102. For example, the generation module 216 may be configured to generate new blockchain data values, new block headers, Merkle roots, new blocks, and other data for operation of the blockchain. The generation module 216 may also be configured to generate fake transactions for a blockchain network 104, where the fake transactions may be generated using random generation, and may include data dependent on the blockchain network 104 and formatting of blockchain data values included in the blockchain thereof. For instance, in one embodiment, a fake blockchain transaction may be a random 64-digit alphanumeric value, and, in another embodiment, a fake blockchain transaction may be a transfer of a random amount of cryptocurrency from one randomly selected blockchain wallet to another randomly selected blockchain wallet from a group of blockchain wallets available to the blockchain node 102.

The blockchain node 102 may also include a monitoring module 218. The monitoring module 218 may be configured to monitor performance values for the blockchain node 102 as part of the functions discussed herein. The monitoring module 218 may receive instructions as input, which may also include data to be used in performing the monitoring (e.g., specifying performance values to monitor), may perform monitoring as requested, and may output a result of the monitoring to another module or engine of the blockchain node 102. The monitoring module 218 may, for example, be monitor performance in the blockchain network 104 for blockchain nodes 102 (e.g., itself and/or other nodes in the blockchain network 104) to identify performance values, which may be specific values as instructed, such as set forth in testing criteria and/or test parameters.

The blockchain node 102 may also include a transmitting device 220. The transmitting device 220 may be configured to transmit data over one or more networks via one or more network protocols. In some instances, the transmitting device 220 may be configured to transmit data to other blockchain nodes 102, requesting devices 106, and other entities via one or more communication methods, local area networks, wireless area networks, cellular communication, Bluetooth, radio frequency, the Internet, etc. In some embodiments, the transmitting device 220 may be comprised of multiple devices, such as different transmitting devices for transmitting data over different networks, such as a first transmitting device for transmitting data over a local area network and a second transmitting device for transmitting data via the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to blockchain nodes 102 that are superimposed or otherwise encoded with new blockchain data values, fake transactions, new blocks for confirmation, confirmed blocks, messages regarding block or transaction confirmations, and other data used in the operation and management of the blockchain, as well as requests for performance data and other data to be used in identifying performance values thereof. The transmitting device 220 may also be configured to electronically transmit data signals to requesting devices 106, which may be superimposed or otherwise encoded with identified performance metrics.

### Process for Performance Testing in a Blockchain Network

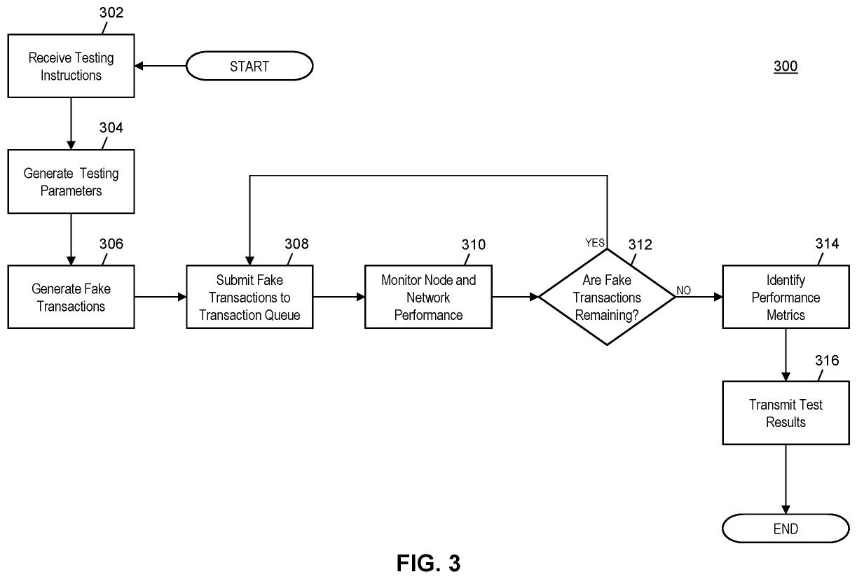

FIG. 3 illustrates a process 300 for performing performance testing in the blockchain network 104 in the system 100 of FIG. 1 through the introduction of fake transactions in accordance with set test parameters.

In step 302, the receiving device 202 of the blockchain node 102 may receive testing instructions, such as may be submitted by the requesting device 106 using any suitable communication network and method, such as via an application programming interface of the blockchain node 102, a web page, an application program, etc. The testing instructions may include one or more testing criteria. In step 304, the generation module 216 of the blockchain node 102 may generate test parameters for performance testing based on the at least one test criteria, which may include, for instance, a number of transactions per second, submission location for fake transactions, performance values to be measured, etc. In step 306, the generation module 216 of the blockchain node 102 may generate a plurality of fake blockchain transactions in accordance with the set test parameters.

In step 308, the transmitting device 220 of the blockchain node 102 may submit a predetermined number of fake transactions into the pending transaction queue for the blockchain network 104. In some cases, the fake transactions may be transmitted to other blockchain nodes 102 in specified geographic locations or in a specified manner (e.g., spread evenly across blockchain nodes 102, etc.), which may be based on the set test parameters. In step 310, the monitoring module 218 of the blockchain node 102 may monitor performance values of the blockchain network 104 and of the blockchain node 102 itself and any other blockchain nodes 102 that have performance values available to the blockchain node 102. In some cases, monitoring of the performance values may include accessing performance values from other blockchain nodes 102 through an application programming interface thereof, requesting (e.g., via a transmission from the transmitting device 220 of the blockchain node 102) performance values from another blockchain node 102, or other suitable method.

In step 312, the blockchain node 102 may determine if all of the generated fake transactions have been submitted into the pending transaction queue, or if the test has otherwise completed (e.g., a specified period of time has expired). If there are still fake transactions in the pending transaction queue (e.g., identified through a query by the querying module 214 of the blockchain node 102), then the process 300 may return to step 308, where new fake transactions may be submitted into the pending transaction queue, if applicable. If there are still fake transactions in the queue but no new submissions to be made, the process 300 may immediately proceed to step 310 to continue monitoring until all fake transactions have been confirmed and added to new blocks that are confirmed and added to the blockchain.

Once all of the fake transactions are in the blockchain, then the process 300 may proceed to step 314, where the generation module 216 of the blockchain node 102 may generate one or more performance metrics. The performance metrics may be generated using the performance values identified for the blockchain network 104 and/or blockchain nodes 102 and the testing criteria received from the requesting device 106. In step 316, the transmitting device 220 of the blockchain node 102 may electronically transmit the determined performance metrics as test results to the requesting device 106 using a suitable communication network and method. In some cases, the performance values used to determine the performance metrics may be included in the test results.

### Exemplary Method for Blockchain Performance Testing

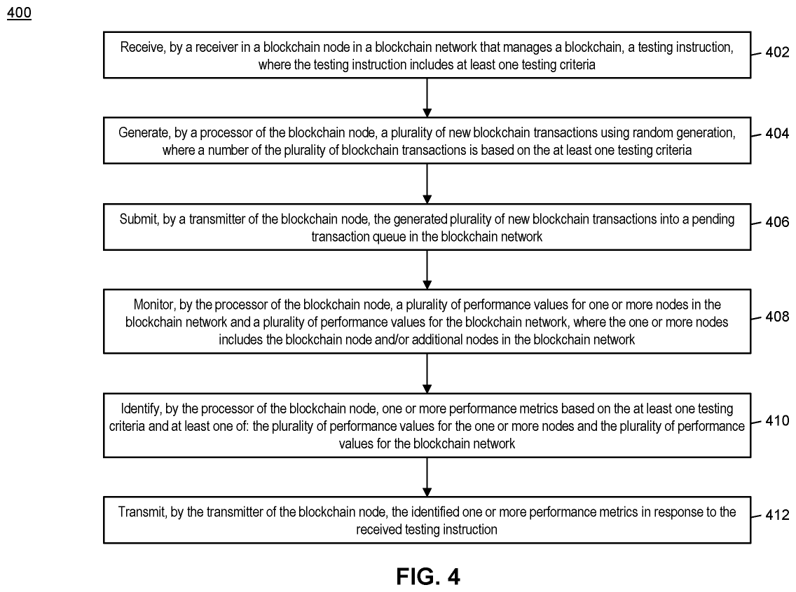

FIG. 4 illustrates a method 400 for autonomous determination of performance metrics in a blockchain network through randomly generated transactions introduced by a blockchain node in the blockchain network.

In step 402, a testing instruction may be received by a receiver (e.g., receiving device 202) in a blockchain node (e.g., blockchain node 102) in a blockchain network (e.g., blockchain network 104) that manages a blockchain, where the testing instruction incudes at least one testing criteria. In step 404, a plurality of new blockchain transactions may be generated by a processor (e.g., generation module 216) of the blockchain node using random generation, where a number of the plurality of blockchain transactions is based on the at least one testing criteria. In step 406, the generated plurality of new blockchain transactions may be submitted by a transmitter (e.g., transmitting device 220) of the blockchain node into a pending transaction queue in the blockchain network.

In step 408, a plurality of performance values may be monitored by the processor (e.g., monitoring module 218) of the blockchain node for one or more nodes in the blockchain network and a plurality of performance values for the blockchain network, where the one or more nodes includes the blockchain node and/or additional nodes in the blockchain network. In step 410, one or more performance metrics may be identified by the processor (e.g., generation module 216) of the blockchain node based on the at least one testing criteria and at least one of: the plurality of performance values for the one or more nodes and the plurality of performance values for the blockchain network. In step 412, the identified one or more performance metrics may be transmitted by the transmitter of the blockchain node in response to the received testing instruction.

In one embodiment, the method 400 may further include identifying, by the processor (e.g., monitoring module 218) of the blockchain node, a plurality of baseline values for the one or more nodes in the blockchain network and a plurality of baseline values for the blockchain network prior to submitting the plurality of new blockchain transactions, wherein the one or more performance metrics may be further based on at least one of: the plurality of baseline values for the one or more nodes and the plurality of baseline values for the blockchain network. In some embodiments, each of the plurality of new blockchain transactions may be a random or pseudo-random 64-digit value. In one embodiment, the testing instruction may be submitted to the blockchain node by an application program executed by the processor in the blockchain node.

In some embodiments, the generated plurality of new blockchain transactions may be submitted into the pending transaction queue over a predetermined period of time. In a further embodiment, the at least one testing criteria may include the predetermined period of time. In one embodiment, the at least one testing criteria may include at least one of: transactions per second, base transactions per second, maximum transactions per second, increase rate of transactions per second, time limit, transaction limit, and hash size. In some embodiments, the plurality of performance values for one or more nodes may include at least one of: processor usage, memory usage, confirmation time, level of synchronization, size of pending transaction queue, and number of transmitted messages.

### Computer System Architecture

FIG. 5 illustrates a computer system 500 in which embodiments of the present disclosure, or portions thereof, may be implemented as computer-readable code. For example, the blockchain nodes 102 of FIGS. 1 and 2 may be implemented in the computer system 500 using hardware, non-transitory computer readable media having instructions stored thereon, or a combination thereof and may be implemented in one or more computer systems or other processing systems. Hardware may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general-purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for autonomous determination of performance metrics in a blockchain network through randomly generated transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for autonomous determination of performance metrics in a blockchain network through randomly generated transactions, comprising:
receiving, by a receiver in a blockchain node in a blockchain network that manages a blockchain, a testing instruction, where the testing instruction includes at least one testing criteria;
generating, by a processor of the blockchain node, a plurality of new blockchain transactions using random generation, where a number of the plurality of blockchain transactions is based on the at least one testing criteria;
submitting, by a transmitter of the blockchain node, the generated plurality of new blockchain transactions into a pending transaction queue in the blockchain network;
monitoring, by the processor of the blockchain node, a plurality of performance values for one or more nodes in the blockchain network and a plurality of performance values for the blockchain network, where the one or more nodes includes the blockchain node and/or additional nodes in the blockchain network;
identifying, by the processor of the blockchain node, one or more performance metrics based on the at least one testing criteria and at least one of: the plurality of performance values for the one or more nodes and the plurality of performance values for the blockchain network; and
transmitting, by the transmitter of the blockchain node, the identified one or more performance metrics in response to the received testing instruction.

2. The method of claim 1, further comprising:
identifying, by the processor of the blockchain node, a plurality of baseline values for the one or more nodes in the blockchain network and a plurality of baseline values for the blockchain network prior to submitting the plurality of new blockchain transactions, wherein
the one or more performance metrics are further based on at least one of: the plurality of baseline values for the one or more nodes and the plurality of baseline values for the blockchain network.

3. The method of claim 1, wherein each of the plurality of new blockchain transactions is a random or pseudo-random 64-digit value.

4. The method of claim 1, wherein the testing instruction is submitted to the blockchain node by an application program executed by the processor in the blockchain node.

5. The method of claim 1, wherein the generated plurality of new blockchain transactions are submitted into the pending transaction queue over a predetermined period of time.

6. The method of claim 5, wherein the at least one testing criteria includes the predetermined period of time.

7. The method of claim 1, where the at least one testing criteria includes at least one of: transactions per second, base transactions per second, maximum transactions per second, increase rate of transactions per second, time limit, transaction limit, and hash size.

8. The method of claim 1, wherein the plurality of performance values for one or more nodes includes at least one of: processor usage, memory usage, confirmation time, level of synchronization, size of pending transaction queue, and number of transmitted messages.

9. A system for autonomous determination of performance metrics in a blockchain network through randomly generated transactions, comprising:
a blockchain network that manages a blockchain; and
one or more nodes included in the blockchain network, where
the one or more nodes includes a blockchain node and additional nodes, and
the blockchain node includes
a receiver receiving a testing instruction, where the testing instruction includes at least one testing criteria,
a processor generating a plurality of new blockchain transactions using random generation, where a number of the plurality of blockchain transactions is based on the at least one testing criteria, and
a transmitter submitting the generated plurality of new blockchain transactions into a pending transaction queue in the blockchain network, wherein
the processor of the blockchain node
monitors a plurality of performance values for one or more nodes in the blockchain network and a plurality of performance values for the blockchain network, where the one or more nodes includes the blockchain node and/or additional nodes in the blockchain network, and
identifies one or more performance metrics based on the at least one testing criteria and at least one of: the plurality of performance values for the one or more nodes and the plurality of performance values for the blockchain network, and
the transmitter of the blockchain node transmits the identified one or more performance metrics in response to the received testing instruction.

10. The system of claim 9, wherein
the processor of the blockchain node identifies a plurality of baseline values for the one or more nodes in the blockchain network and a plurality of baseline values for the blockchain network prior to submitting the plurality of new blockchain transactions, and
the one or more performance metrics are further based on at least one of: the plurality of baseline values for the one or more nodes and the plurality of baseline values for the blockchain network.

11. The system of claim 9, wherein each of the plurality of new blockchain transactions is a random or pseudo-random 64-digit value.

12. The system of claim 9, wherein the testing instruction is submitted to the blockchain node by an application program executed by the processor in the blockchain node.

13. The system of claim 9, wherein the generated plurality of new blockchain transactions are submitted into the pending transaction queue over a predetermined period of time.

14. The system of claim 13, wherein the at least one testing criteria includes the predetermined period of time.

15. The system of claim 9, where the at least one testing criteria includes at least one of: transactions per second, base transactions per second, maximum transactions per second, increase rate of transactions per second, time limit, transaction limit, and hash size.

16. The system of claim 9, wherein the plurality of performance values for one or more nodes includes at least one of: processor usage, memory usage, confirmation time, level of synchronization, size of pending transaction queue, and number of transmitted messages.
